(19) United States
(12) Patent Application Publication
(10) Pub. No.: US 2026/0310910 A1
(43) Pub. Date: Oct. 8, 2026

(54) ULTRA-RELIABLE REFLECT GENERATIVE AI AND UTILIZATION SYSTEM THEREFOR

(71) Applicant: Dr. NakaMats Innovation Institute, Tokyo (JP)

(72) Inventor: Sir Dr. Yoshiro NakaMats, Tokyo (JP)

(21) Appl. No.: 19/482,049

(22) PCT Filed: Jun. 28, 2024
(86) PCT No.: PCT/JP2024/023663

§ 371 Date: Nov. 6, 2025

(30) Foreign Application Priority Data
Jun. 28, 2023 (JP) 2023-106532
Jul. 6, 2023 (JP) 2023-111773
Jun. 25, 2024 (JP) 2024-102437

(51) Int. Cl. G06F 40/58; G06F 3/16; G06F 40/20; G06K 19/06; G07C 13/00; H04R 1/02

(52) U.S. Cl. CPC G06F 40/58; G06F 40/20; G06K 19/06037; G07C 13/00; G06F 3/167; H04R 1/028

(57) ABSTRACT

[Problem] There is a need to increase the accuracy of generative AI in relation to the Japanese language. [Solution] In the present invention, reflect generative AI and generative AI having improved accuracy in Japanese/English translation facilitate, inter alia, problem consultation using a microphone and a speaker, conversations with the deceased, election activities using a connection function such as a QR code (trade name), and also facilitate content consultation related to books and magazines and explanations related to product manuals.

### TECHNICAL FIELD OF THE INVENTION

This invention relates to a revolutionary improvement of the accuracy of problem-solving methods of generative AI and a means to efficiently use such AI, i.e., counseling on problems and memorials for the deceased, election campaign methods that even the elderly can use AI on voters' smart phones, descriptions of book content, and user manuals.

### BACKGROUND TECHNOLOGY

Currently, various documents and paintings can be created using generative AI. However, there is a problem with accuracy, and the downside of generative AI is that it “tells believable lies.” The reason for this is that GPT only compares AI vectors and arranges them in several steps, which lacks authenticity and is dependent on how the past AI data has been selected. Moreover, generative AI is inaccurate because it has little Japanese-language data and is insufficiently trained.

When Japanese language generative AI is used, questions and answers are mainly input via text input, and verbal consultations and questions can be easily answered in only a limited number of areas, and with poor levels of accuracy. When using AI, Japanese users consult about their problems verbally in Japanese, but when voice recognition is used, the meaning may be missed with text generated nonetheless.

In addition, when it comes to election activities using AI, the ban on election campaigning using the Internet and other methods was lifted in 2013 with amendments to Japanese election law (by members of the Japanese Diet). As a result, AI-based activities are also being conducted.

Young people can easily get used to the Internet environment and view information online, but older voters are less likely to view information on the Internet than on paper or campaign posters, and it is extremely difficult for such older voters to get information through question-and-answer sessions using AI.

In terms of the overall age groups of voters, more voters are exposed to television, election posters, newspaper election ads, and election bulletins than they are to online election information. For example, in the 2020 Tokyo gubernatorial election, only about 30% of voters used the special website set up by the Election Administration Commission or consulted the Internet, while about 50% of voters read election bulletins and election posters distributed at home, and about 50% consulted TV and radio election reports and political broadcasts. TV and radio election coverage and political news broadcasts are also consulted by about 50% of voters. The use of the Internet remains low. Voters are still influenced primarily by, paper, visual, and audio information.

Moreover, there are not so many candidates running for office who are also elderly. Because even those with clear minds and experience need to campaign and to campaign quite hard, which is physically demanding on the elderly. For example, in gubernatorial elections, the maximum age at the expiration of term is 88. By using this AI remotely, the elderly can also campaign and serve as legislators.

The present invention eliminates these shortcomings, dramatically improves the accuracy of AI while facilitating its use.

### PRIOR ART CITATIONS

### Patent Documents

Patent document 1: Patent Publication 2022-517292
Patent document 2: 2015-052992
Patent document 3: JP-A-2008-250367
Patent document 4: Laid-Open Patent Application 2002-041718

### SUMMARY OF THE INVENTION

### Problems to be Solved by the Invention

The following are problems that are addressed by the generative AIs own database.
1. Due to the scarcity of Japanese language data, answers to Japanese questions are erroneous or unanswerable.
2. There may be bias in the model, which may reduce the accuracy of the model.
3. The fact that there remain differences from human language: natural language processing technology is used, but responses are less than perfect.
4. The absence of out-of-context information: Since responses are based on an algorithm, only past conversational information, etc., can be used to make decisions.
5. Logical inconsistencies: Responses are sometimes inconsistent in terms of logic.
6. A sense of unnaturalness in communications with others.

Patent document 1 is a technique for improving the accuracy of text processing in machine learning by adding a knowledge graph to improve the semantic representation of text. However, this is not sufficient for the current algorithm that seeks optimal responses.

Patent document 2 is a technique for improving the accuracy of Japanese language text processing in machine learning.

Patent document 3 is an invention filed by the inventor of the present application, and discloses a tool for developing an election campaign in which a two-dimensional code is installed on a TASUKI [TASUKI annotation tool] or the like and an e-mail address is read, and the voter and candidate communicate with each other by e-mail.

Further, in Patent Document 4, each candidate creates a database, and voters can enter the designated information aggregation site via the Internet to pose questions and to exchange opinions with the candidates by exchanging candidate information and email.

However, with the establishment of high-speed Internet networks capable of high-speed video distribution, and the fact that even the elderly now have smartphones, and that the requirements of the Public Offices Election Law have been relaxed, there should also be changes in means of communications and in exchange of information.

All voters, including the elderly, need a system that allows them to use their smartphones to obtain answers to individual questions in a simple and secure Internet environment, and to learn more about candidates and political organizations.

The present inventor has found a way to improve the inadequate performance of AI and has invented a method to dramatically improve the performance of AI for the Japanese language. Her has invented an election campaign system using the AI on the Internet, which enables even the elderly to run for office with the candidates having to move, wherein campaigns can be conducted efficiently, and voters of all generations can fully understand the candidates or political organizations and gain more trust from them.

### Means of Solving the Problems

The present invention, which solves these problems, is characterized by unlimited reflections of AI answers to obtain generative AI responses that raise the AI answer to unlimited levels of precision.

In other words, the AI is further asked “Is that right?”, “Is that a better answer?”, etc., and this process is repeated n times to obtain more accurate responses.

Furthermore, the invention features a means of inputting data in Japanese, automatically converting the input to English, and answering in Japanese with the AI response raised to the highest degree of accuracy.

Using the generative AI of the present invention, the AI is trained with information on the candidate's claims, policies, background, awards, inventions, social media conversations and posts, interviews, family information, political claims, background, etc. The AI can be used for bulletin boards without election posters, etc., and for street speeches without candidates. That is, when voters use a dedicated application on their smartphones to recognize a candidate's face, name, 2-dimensional code, letters, code, frame images, or characters in the title of a claims board, the candidate's data is identified over the Internet, and the data, images, videos, and sounds are automatically downloaded, viewed, and watched. This is a method of using the AI system that enables voters to ask verbal questions and to receive responses with a high level of accuracy.

This enables the elderly, the infirm, those who cannot speak, and those who are handicapped in their ability to move (hereinafter referred to as “the elderly, etc.”) to run for office and to campaign with minimal physical burden. Moreover, by using this AI, voters of all ages can fully understand the candidacies by the elderly, etc.

### Effects of the Invention

The effect is to obtain the most accurate AI response that is most likely to be correct. It also has the effect of allowing users to input questions to the AI in the Japanese language and to obtain the most correct and accurate responses from the AI in Japanese.

Furthermore, by utilizing AI trained on candidate information during elections, (1) the need for massive poster campaigns and leaflet distribution can be eliminated.
1) Reduction of manpower and cost for putting up posters.
2) Candidates themselves will no longer need to make speeches or make other kinds of efforts.
3) AI will respond on behalf of the candidate or political organization.
4) There will; be a saving of candidate effort and expenses.
5) Elderly and other physically challenged persons who may not be physically fit can easily run for office.
6) People with functioning intelligence can be utilized.

There will be fewer impediments to political campaigns and individuals with extensive experience can effectively use their knowledge to improve Japan.

This is an effective method.

### BRIEF DESCRIPTION OF DRAWINGS

FIG. 1 Generative AI of the prior art (GPT)

FIG. 2 Flowchart of the first embodiment of the invention

FIG. 3 Flowchart of the second embodiment of the invention

FIG. 4 Flowchart showing the third embodiment of the invention

FIG. 5 Flowchart showing the fourth embodiment of the invention

FIG. 6 Flowchart showing the fifth embodiment of the invention

FIG. 7 Flowchart showing the sixth embodiment of the invention

FIG. 8 Flowchart showing the seventh embodiment of the invention

FIG. 9 Top view of the eighth embodiment of the invention

FIG. 10 Front view of the ninth embodiment of the invention

FIG. 11 Front view of the tenth embodiment of the invention

FIG. 12 Flowchart showing the 11th embodiment of the invention

FIG. 13 12th embodiment of the invention.

FIG. 14 13th embodiment of the invention.

FIG. 15 13th embodiment of the invention: case study of posters.

FIG. 16 Processing flow of a 13th embodiment off the invention.

FIG. 17 Processing flow of a 14th embodiment off the invention.

FIG. 18 15th embodiment of the invention: a gazette case study.

FIG. 19 Processing flow of a 15th embodiment of the invention.

FIG. 20 Processing flow of a 16th embodiment of the invention.

FIG. 21 Processing flows of the 17th and 18th embodiments of the invention.

### EMBODIMENTS OF THE INVENTION

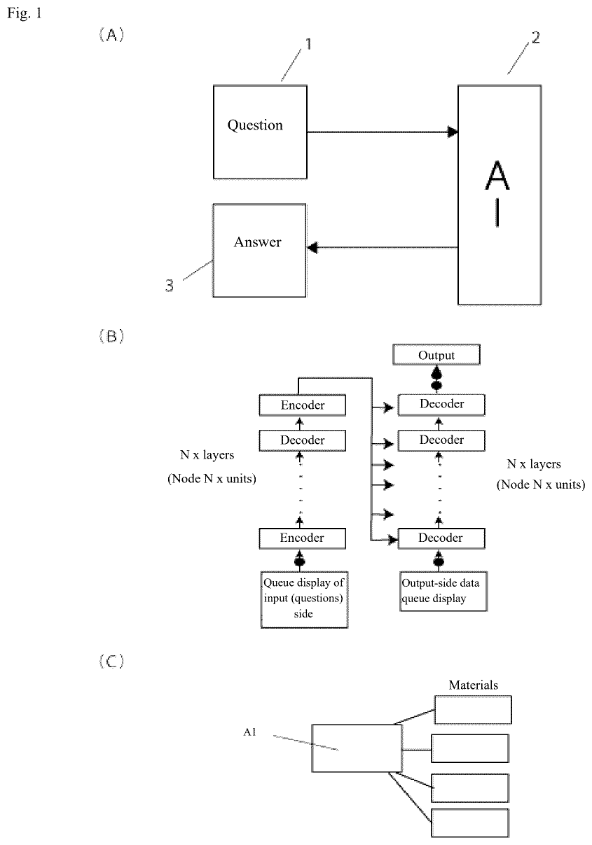

FIG. 1 shows a generative AI of the prior art. In November 2022, Open AI strongly urged Japan's Prime Minister to adopt generative AI. It is anticipated that big data is expected will be used in various fields. While rules have been considered, in the present invention, the inventor focuses on accuracy.

The inventor has determined from databases that the following problems exist in known generative AI.
1. There may be bias in the model: generative AI produces responses based on the data that was used for training, so there is potential for bias. This may reduce the accuracy of the model.
2. [Generative AI] remains different from human language: Generative AI is trying to understand human language using natural language processing techniques, but it is not yet perfect and cannot generate perfect responses.
3. [Generative AI] does not use out-of-context information: Generative AIs generate responses based on algorithms, so information cannot be obtained from other than the context of past conversations. Therefore, out-of-context information cannot be used. Thus, there are delays in optimizing the latest information.
4. Logical inconsistency: Responses produced by generative AI may have grammatical and logical inconsistencies.
5. Some people feel uncomfortable with machine language. Generative AI is not yet perfect and sometimes generates responses that sound like machine language. This can make such systems feel unnatural in communicating with people. Furthermore, even an AI that has learned from a vast amount of data, or a generative AI, will choose some kind of answer to questions and produce “earnest lies.”
6. The accuracy of response generation in the Japanese language is poor because English information context is predominant.
7.
The above problems are known and noted.

The key points of known generative AI (GPT) are:
1. Deep learning model
   (1) Analysis from the head to the bottom to discern meaning.
   (2) The use of transformers to improve the accuracy of the sequential order.

### Vectorization of Each Word.

It is important to have an attention mechanism (to process information while focusing on factors of high importance).

The derivation of relevance so that the AI can easily understand the meaning of questions.

The structure of the transformer is shown in FIG. 1 (B), but it is repeated many times to increase its power by grasping the meaning, not by asking for it.

Moreover, the information is insufficient only in the lower layers of the program's multilayers. A good answer is finally obtained when the upper layers of the program are reached.

The system is not good at abstractions.

These are the characteristics of known generative AI.

Further, known generative AI (GPT) features the use of a large language model with a table of contents of important parts and an attention mechanism rather than series stacking.

Specifically, the algorithm (processing method) in the case of GPT (Generative Pretrained Transformer), which is a known generative AI, is pre-trained on a large amount of text data using a transformer of the aforesaid neural network structure.

As shown in FIG. 1 (B), the transformer divides the input text into words or strings of characters, adds positional information to each of them, and compresses and consolidates them by encoder as appropriate. The relationship between each word or character is calculated by the aforementioned attention mechanism (self-attention function or multi-head attention function) to understand the meaning and context of the text input to the encoder, and using the information received from the encoder and the self-attention, the next word or character to be generated is predicted through the decoder, stratified, answered, and output.

The GPT then generates the sentences that continue the text that has been inputted.

In the pre-learning phase, GPT learns language knowledge and patterns from large text data on the Internet (e.g., Wikipedia, news articles, etc.), masks (hides) parts of the text, and performs the task of predicting the masked parts from the remaining parts to acquire general language rules and grammar by masking parts of the text and predicting the masked parts from the remainder of the text.

After pre-learning, the model is fine-tuned to specific tasks (e.g., dialogue, summary, etc.) in a phase called transfer learning, in which the model learns the knowledge and skills required for the task from task-related text data (e.g., dialogue history, summary sentences, etc.) so that it can respond to the specific task.

In transfer learning, feedback learning (so-called supervised learning) is used to prepare output (answers) to input (questions), and GPT itself performs further learning based on the above pre-learning (so-called unsupervised learning), which improves accuracy in various fields and makes generative AI applicable to any field.

For specialized matters, a human evaluator will further refine the model by evaluating the answers generated by GPT.

This invention is a technology that attempts to make the generative AI, after going through such learning, more accurate in responding to questions.

In particular, the invention provides highly accurate response generation by changing over to a Japanese language processing and translation process that is sufficiently communicative and reliable in the Japanese language.

The following is a detailed description of the embodiment of the invention with reference to the drawings.

The idea is to increase the reliability of AI by repeating the learning process many more times for each question to the AI.

For example, a single convex lens can only magnify to a certain size.

However, when two convex lenses are superimposed, a microscope can be used to magnify even the smallest of details.

This invention is similar to superimposing two convex lenses; it is an invention that obtains higher certainty than existing generative AI by superimposing two or more huge AI datasets.

Furthermore, in the generative AI of the prior art, conversational and investigative functions are performed in English, using big data and sentences that are similar to human conversation. In the case of Japanese-language support, there is a lack of cumulative data, and there is also the problem of accuracy.

In other words, the natural language processing technology of generative AI is inadequate for learning Japanese and for assigning importance to Japanese words. There also problems with accuracy and learning.

The deep learning (machine learning) methods used in known generative AI systems are based on English databases from which natural language processing models are created and learned, so even if though they may be accurate in assigning importance to English text, they are not adequate for learning Japanese.

For example, even in Open AI's multilingual model, the Japanese error rate is 26% higher than it is for English.

The present invention is an innovative method to solve the above problems while using a generative AI device.

The highly accurate Japanese responses from generative AI can then be deployed in various activities and products.

The following is a description of the specific processing form in which this generative AI is used in the 8th and subsequent forms of the invention

### First Embodiment of the Invention

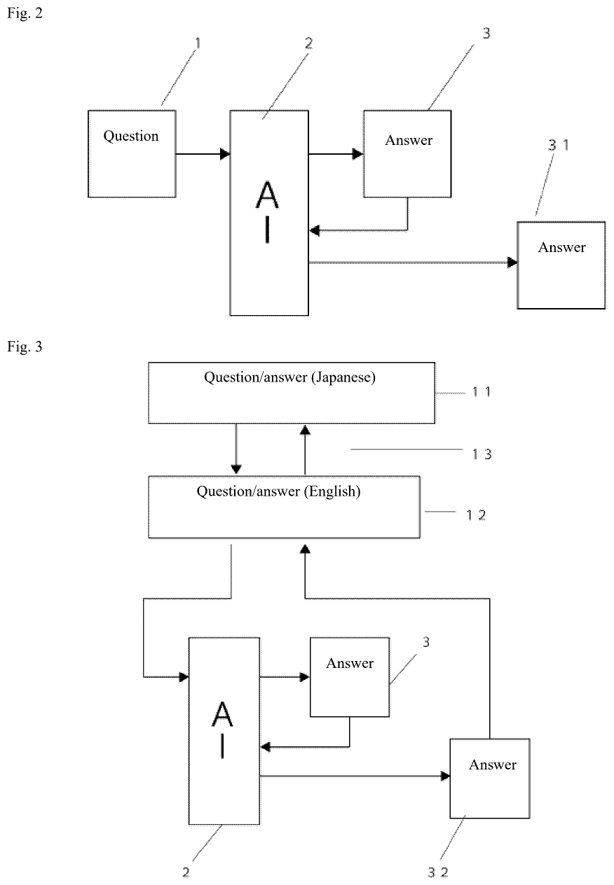

FIG. 2 illustrates a first embodiment of the invention, which improves the accuracy of an answer 31 by asking the AI2 the answer 3 obtained by asking the AI, (words or text input) 1, again to the AI2 in order to further improve the accuracy over, for example, a known generative AI.

Then, the aforementioned AI's answer is asked again, but in addition to the text of the AI's answer and the words or document of the original question, input is added that asks one more time if the answer is really good. That is, it adds words or written text that question again, such as: “Is this truly correct?”; “Conduct another investigation”; or “Provide a reliable answer once more.” This allows for different weighting of words, reaching higher level data and leading to more correct and accurate answers. This process is unlike known AI, where the questioner simply asks a question and the AI simply gives a low-level response, or where the questioner prepares an answer and the AI learns the error.

By examining the contents in more detail from the database, the AI itself can match the senses of the person doing the search as closely as possible and obtain more reliable answers 31.

This was named the Reflection AI method.

### Second Embodiment of the Invention

FIG. 3 shows a second embodiment of the invention, characterized in that the input language for questions to the aforementioned AI2 is a language other than English, such as Japanese 11.

This is because the majority of known generative AI data is in English 12, and very little of it is in Japanese.

The inventor has also devised an invention to obtain highly accurate answers using Japanese language input 11, for which he has filed a separate patent application.

This second example uses the inventor's invention described above to further improve the accuracy of the known generative AI.

### Third Embodiment of the Invention

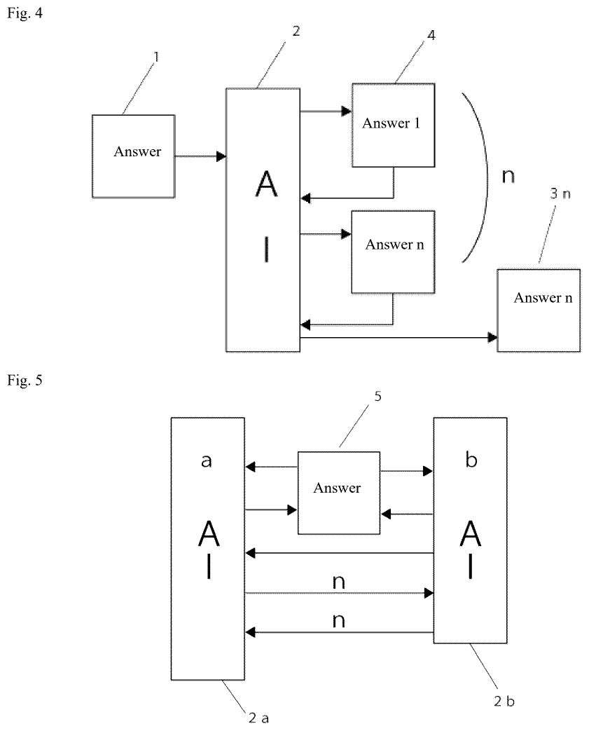

FIG. 4 shows a flowchart of a third embodiment of the invention wherein by repeating the “asking AI again for AI's answer” 4 n times as in Embodiment 1, the content of answer n is richer and more accurate than that of answer 1.

In the case of “asking the AI n times for the AI's answer,” the words of the AI's answer may be broken down and the AI may be asked again, with emphasis on that group of words.

The questioner can decide which words are important, or words that are important can be derived by text mining techniques, emphasized, and asked again by the AI.

Also the aforementioned question words can be added the question asked again.

Furthermore, in known natural language processing, the present invention also includes an embedded vector (weighting) direction of a small vector (weighting) word changed to investigate the language.

According to the third embodiment of the invention, even difficult answers can be recognized with greater clarity.

### Fourth Embodiment of the Invention

FIG. 5 shows a flowchart of the fourth embodiment of the invention, an invention that uses different AIs 2a and 2b to obtain even more accurate answers.

AI 2a and the generative AI 2 (not shown) to repeat the question and answer 5. Simultaneously, AI 2a poses the identical question and the response document 5 generated from A 12 to AI 2b, exchanging queries n times. If the response 5 generated by AI 2b differs from the response generated by AI 2a, the mutual questioning process between AI 2a and AI 2b continues.

The invention then allows the AI2 that generates the aforementioned input information to obtain the answer with greatest precision.

### Fifth Embodiment of the Invention

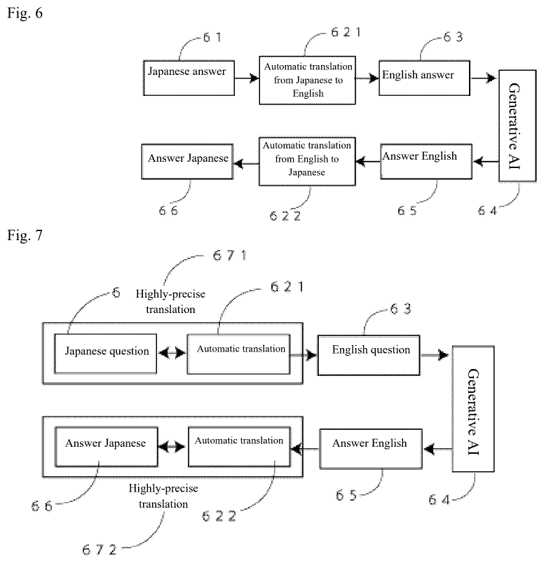

FIG. 6 shows the fifth embodiment of the invention, in which the input to the generative AI is a question 61 in Japanese, 63 input to the generative AI in English through automatic translation 621 from Japanese to English, and the AI's response 65 is given in Japanese through automatic translation 622 from English to Japanese, and the response 666 in Japanese.

This invention is not about the trainer (teacher) preparing mere words and letting the translation model learn from the errors.

Since the generative AI responds on the basis of a vast amount of data in English, the invention provides highly reliable questions and answers.

According to the fifth embodiment of this invention, the accuracy of AI responses can be improved even when input is performed in Japanese.

### Sixth Embodiment of the Invention

FIG. 7 shows the sixth embodiment of the invention, which is a method of inputting 63 to the AI in English through a Japanese-to-English translation function 67 1 with improved translation accuracy, and outputting 65 from the AI in better and more accurate Japanese 66 through a translation function 67 2 with improved translation accuracy from English to Japanese.

In order to further improve accuracy over known translation functions, the method is to ask the translation function a question, and then ask the English or Japanese answer obtained to the translation function again.

In other words, to reinterrogate the translation means to repeat the back-translation and forward-translation of the translated word. By repeatedly adding importance and translating again, the meaning and purpose of words are clarified and accuracy is improved. This leads to more accurate and precise translations with different word weights.

According to the sixth embodiment of the present invention, Japanese input can significantly improve the accuracy of responses of known AI devices.

Any known generative AI is expected to improve accuracy. In addition, it is easy to input data.

### Seventh Embodiment of the Invention

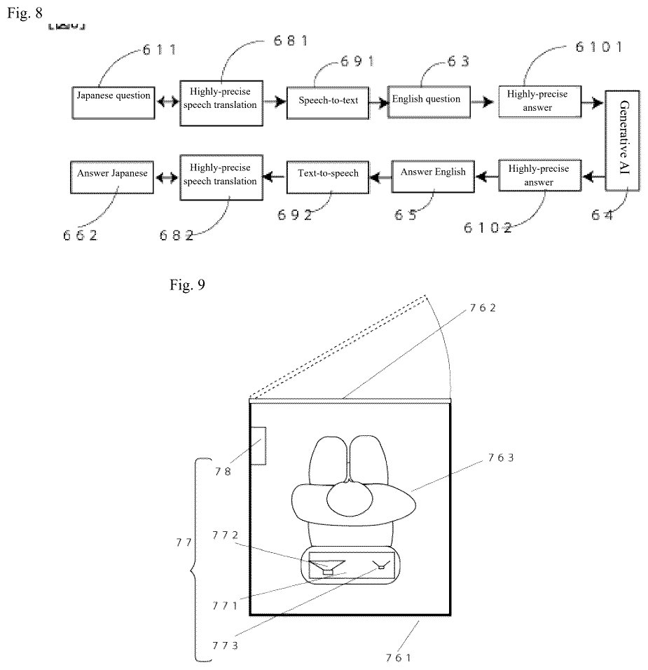

FIG. 8 shows the seventh embodiment of the invention, which is a processing method that adds a Highly-precise response system 6101, 6102 to the speech recognition accuracy increased in 681, 682 as described above.

The AI takes a Japanese vocalization 611 as input, performs translation 681 and character conversion 691 with improved speech recognition accuracy, and then reverses the output character, question 63, to a Japanese vocalization, and based on the Japanese vocalization again, the questioner further emphasizes the important points in the Japanese vocalization, for example, by inputting three different English sentences to the generative AI. This is then input into the generative AI.

The meaning and intention of the translated words from Japanese are added to increase the accuracy of the translation.

Automatic translation can be a text and/or speech translation model with increased translation accuracy, as in the seventh embodiment, or any known translation model may be included in the present invention.

In addition to Japanese, for example, Chinese, Korean, Spanish, German, and other languages are also included in this invention.

According to the seventh embodiment of this invention, questions can be asked in Japanese, and anyone can easily obtain highly accurate answers.

The eight embodiment of the invention onward show a specific embodiments of the present invention that utilize the highly accurate Japanese response generative AI of the present invention.

### Eighth Embodiment of the Invention

The eighth embodiment of the invention is shown in FIG. 9, and is specifically an invention of what can be called a “worry counseling center” such as a “confessional” of a church or a toilet room 761.

As shown in FIG. 9, a box-like room 6 such as a toilet 761 with a door 762 enclosed on all four sides or a space partitioned by curtains is prepared, and when the person seeking counseling 763 talks about his/her problems while sitting on the toilet 761, the microphone 773 behind the individual collects the sound and inputs it into the main unit 771 of the inventive device installed under the toilet's water tank, and the answer to the problem is given to the person seeking counseling 763 by means of audio through the speaker 772 disposed behind the device.

The content does not represent atonement for the past, but the present invention is appreciated [by users] because it provides answers for consultation on unknown matters, such as uncertainties or hopes for the future.

The location of the invention installation device may be in an area where there is no enclosure. This will further increase accuracy by creating a database of not only past data, but also future information.

The inventive device 77 (main unit 771, microphone 773, and speaker 772) is a device having a server main unit with a highly accurate Japanese response generative AI trained in life consultation cases as shown in Embodiments 1~7, and the main unit, microphone, and speaker are an integrated unit are preferably installed in a private room or the like.

A QR code (registered trademark) may be provided in this enclosed room, which is read by a smart phone, and connected by smart phone to a generative AI in the main unit of the inventive device installed in another location for wireless consultation and audio response.

In more detail, the inventive device 7 also includes an Internet-connected device (so-called personal computer or smartphone) with an application that reflects the answer to the question, a display device such as a monitor, and a power supply device such as a battery, and a power cord. When used for business, as shown in FIG. 9, a coin box 78 is provided as an example of the inventive device, and the main unit 771 of the inventive device is activated when a user puts money in the box.

### Ninth Embodiment of the Invention

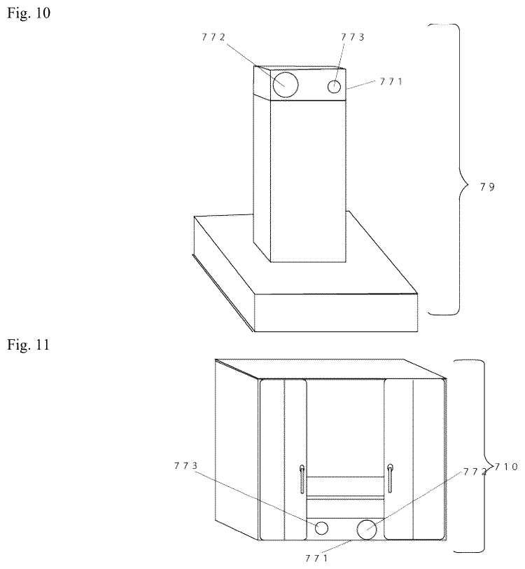

The ninth embodiment of the invention, as shown in FIG. 10, is installed the main unit of the device 771, microphone 773, and speaker 772 on a grave 79 or in a gravestone, so that when visiting the grave, people can talk with the deceased, receive a response, and talk to the deceased about current problems, listen, and exchange love with them. This is an invention that will completely change the concept of graves in the future.

When the 77 device is installed in a grave, it may be a portable device that can be moved, integrating the main unit 771, the microphone 773, and the speaker 772. Alternatively, if the system is to be installed as an all-weather type to withstand wind and rain, a solar power supply system can be installed.

A QR code (registered trademark) may also be provided on the grave, which is read with a smartphone, and the smartphone may be used to connect to the generative AI in the main unit of the invention device installed in a different location to talk and consult about one's problems wirelessly.

### Tenth Embodiment of the Invention

The tenth embodiment of the invention is a butsudan [home Buddhist altar] As shown in FIG. 11, it is an invention of a completely new butsudan 710 consisting of the main unit of the device 771, microphone 773, speaker 772, tablets, and a portrait of the deceased, as well as the aforementioned grave, and is an epoch-making butsudan that can interact with the deceased, as in the aforementioned “room,” “grave,” and “butsudan.”

This invention will inspire a religious revolution.

A QR code (registered trademark) may be provided on the butsudan of the invention, which is read by a smart phone, and connected by smart phone to the generative AI on the main unit of the invention device installed in another location to wirelessly talk to each other and discuss problems.

### Eleventh Embodiment of the Present Invention

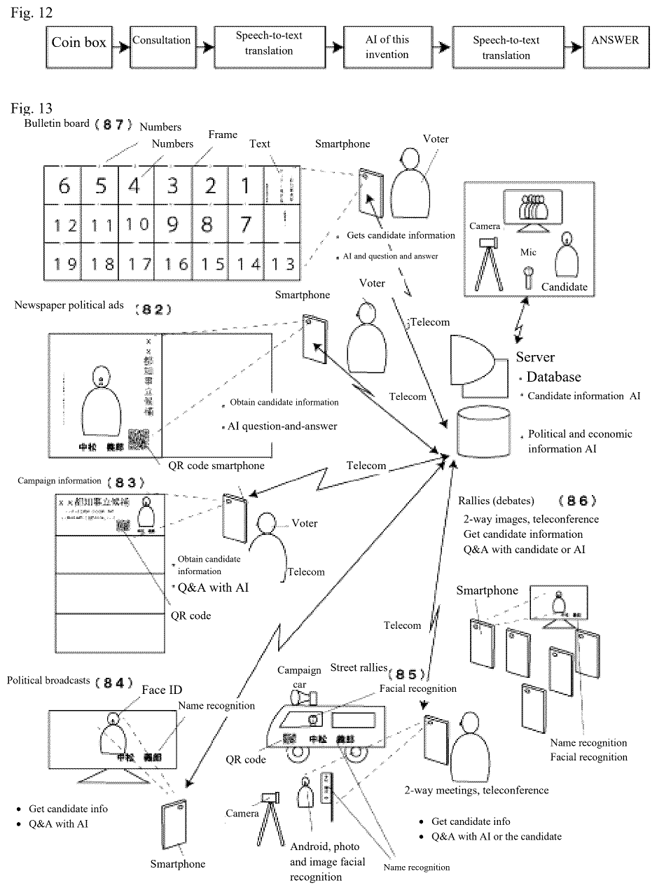

The 11th embodiment of the invention, as shown in FIG. 12, is a business model of the AI that generates the embodiment of the invention, which sets a fee lower than the subscription fee, and upon payment of the fee, receives the matter to be consulted on from a individual seeking consultation via voice, converts the information into spoken text and proofreads it, obtains an answer from the AI, which converts the information into speech and vocalizes it to the individual seeking consultation.

According to the eighth embodiment of the invention, the individual seeking consultation only needs to generate a consultation and has the advantage of receiving a voice response from an expert on the spot.

The means of this invention embodiment may be used as a method for training AI. Automatic document translation and automatic speech translation in the present invention is text translation and speech translation with AI functions, but known technologies may be used.

### Twelfth Embodiment of the Invention

FIG. 13 illustrates the specific method of using the generative AI of the invention 2, 64 in an general view of the 12th embodiment of the invention for an election campaign 80.

Basically, the candidates do not move. Voters use smartphones. The method is characterized by remote activities. Furthermore, posters do not have to be posted on bulletin boards. Candidates do not even have to ride in a campaign car. Candidates do not need to make speeches in the streets.

In other words, campaigns consist of question-and-answer communication with individual voters' smart phones, with automatically generated documents or voice responses by the generative AI of the invention via the Internet. Remote working of the candidate's campaign.

The method using this generative AI of the invention is illustrated in FIG. 13, which shows an overall view of a QR code (registered trademark) and other link connection functions provided on posters, election bulletins, and other election-related materials in a campaign 80. The method of using the AI system is characterized in that the AI 2, 64 system, which has been trained with candidate information, responds to questions asked by a questioner, such as a candidate, by means of text or voice.

First, a list of differences between the known campaigns and the 80 campaigns for election of the present invention is presented.

TABLE 1
Comparison of election campaign activities

| | | Campaign using generative AI | |
|---|---|---|---|
| Main items | Prior art | Overview of embodiments | Notes |
| Set up campaign office | Run office | Set up website. | Use of telecommunications |
| | | Create application that uses | devices and the cloud, develop |
| | | smartphones for generative AI | dedicated app. |
| | | links | |
| | | (location is small office or | |
| | | home) | |
| Produce and distribute campaign | Produce postcards, | Post on social media, send | Consider the use of known tools |
| postcards | acknowledgments, and send by | emails, promote installation in | like X, Line, Skype, weChat, |
| | mail. | smartphones | Facebook, YouTube, TikTok |
| | | | videos |
| Campaign ads in newspapers | Produce, photograph, post | Production | Automatically distribute content |
| | campaign promises only | Use QR codes, face photos, etc. | tailored to voters' needs. |
| | | as triggers and link to generative | |
| | | AI | |
| Distribute flyers | Distribute activists | N/A | |
| Campaign public information | Produce and put up posters | Production | Automatically distribute content |
| | | Use QR codes, face photos, etc. | tailored to voters' needs. |
| | | as triggers and link to generative | |
| | | AI | |
| Put up posters | Produce and put up posters | Putting up of poster: not | |
| | | applicable | |
| | | Use as generative AI triggers: | Login using dedicated |
| | | text like (1) “Governor of XX | smartphone app. Use camera to |
| | | election,” or (2) bulletin board | pass over image or text |
| | | frame images and QR codes as | recognition for locational |
| | | (3) frame area symbols (number) | recognition and automatically |
| | | | distribute content tailored to |
| | | | voters' needs. |
| Use of campaign cars for | Rent vehicles, attach name | Using QR codes, Facebook | Voters view live events on their |
| campaign activities | placards, prepare flyers, | photographs, names, etc. as | smart phones, engage in |
| | microphones, speakers, | triggers linked to generative AI. | question-and-answer sessions |
| | batteries, etc. | It becomes possible to use | with generative AI, and |
| Street speeches | Candidates speak and move | generative AI for question-and- | information is distributed in this |
| | between actual locations. | answer sessions. | way. Live distribution may also |
| | | Or use microphones, cameras, | be used. |
| | | speakers for remote speeches. | |
| | | May also be used for live | |
| | | distribution. Alternatively, the | |
| | | Metaverse can be used for | |
| | | communications. | |
| Individual speeches | Candidate themselves speak and | QR codes, face photographs, | Images and conversations can |
| Public lectures | respond at actual locations | names, etc. are used as triggers | also be held using X-Space, Line |
| Debates | Images of stored and posted to | for generative AI. | group meetings, Skype, Zoom, |
| | websites | Question-and-answer sessions | Teams, WeChat. |
| | | are enabled by generative AI. | Chats can also be held using |
| | | Or use microphones, cameras, | Facebook and WhatsApp. Two |
| | | speakers for remote speeches. | way communications can be |
| | | They also be used for live | used to distribute information |
| | | distribution. Alternatively, the | live). |
| | | Meta verse can be used for | The candidates themselves can |
| | | communications. | appear, or avatars of the |
| | | | candidates can be used. |

In terms of building software, candidates for election create dedicated applications for smartphones that can recognized by means of facial recognition, image recognition, text recognition, or 2-dimensional code recognition.

They then promote the distribution and installation of these applications among voters.

The server will build a training invention generative AI 2 and 64 which is provided with candidate information. Using this form 1~7, it will be a high precision generative AI2, 64 that can answer questions and answers in voice (Japanese).

As for bulletin boards, voters essentially can start a dedicated application on their smart phones and hold it up to the bulletin board to download and receive answers to questions with the generative AI 2 of the invention and 64, without the need to put up posters in the “Poster Display Area 81”.

This has the effect of reducing the number of posters, since candidates do not have to go to the trouble of creating a large number of posters and posting them in, for example, 10,000 or more locations throughout Tokyo.

For election bulletins 83 and election advertisements 82 published in newspapers, a special application can be made into data such as the name of the candidate, face photo, 2-dimensional code, text, and the generative AI of the invention 2, 64 or home page or database, image or video.

For campaign cars, street speeches 85, political broadcasts 84, personal lectures, and debates 86, whereas in the past, candidates were seen and heard solely at the venue, the system is basically remote, and voters can use their smart phones to access this system via links using 2-dimensional codes, the candidates' faces, the words of their promises, etc., the voters accessing the AI 2, 64, etc. can ask and receive answers to their questions.

The candidate's image may be projected, or a cloned android (registered trademark) or avatar may be made to resemble the candidate, and the aforementioned generative AI of the invention 2, 64 may be used for voice question-and-answer sessions.

In addition, the audio can communicate in the form of live two-way communication between the candidates and the voters at the venue.

The dedicated apps described above may be linked to known communication tools (including Line, YouTube, Instagram, X (formerly Twitter (registered trademark)), Facebook (registered trademark), TikTok, What's Up, WeChat, LinkedIn, Snapchat, Pinterest, or KakaoTalk). The means of communication may then be text and/or video and/or audio, and may be communication between the voter and the candidate himself/herself.

Moreover, the generative AI 2 and 64 are be linked to a known AI such as ChatGPT AI, trained with candidate information using the embodiment of the invention (using the server of the linked AI system), and will conduct question and answer sessions using this AI.

Using the method and equipment described above, a campaign 80 can be conducted and candidates can, for example, run for office and advocate and be elected even by the elderly by providing electronic equipment such as microphones, cameras, database storage devices, and communication server PCs in individuals' homes. Electronic devices such as database storage devices and/or communication server PCs may also be located in the cloud.

### Thirteenth Embodiment of the Invention

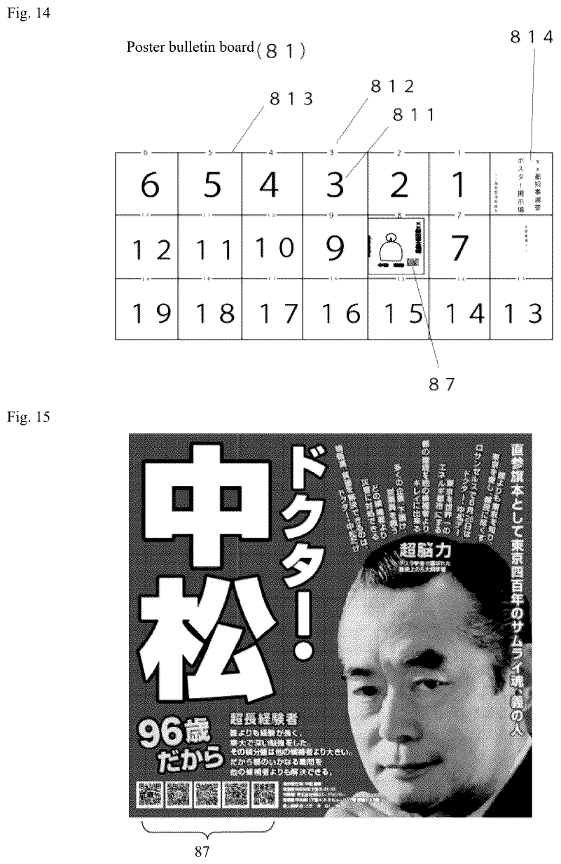

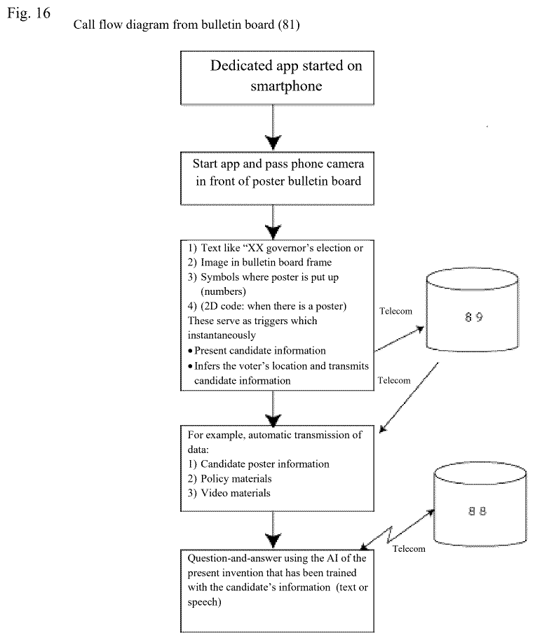

FIGS. 14, 15, and 16 show a more specific example of the embodiment of the 12th embodiment of the invention in a 13th embodiment. FIG. 14 shows an election poster bulletin board 81, FIG. 15 shows an example of an election poster with a 2-dimensional code 87, and FIG. 16 show the processing flow for the bulletin board. First, voters launch the dedicated app installed on their smartphones. The app displays the number (code) posted via database 89 and information on whether election posters are displayed. The smartphone camera starts up, and when held over the aforementioned election poster display area 80, it captures either: A square display frame 81; a code provided within the frame (e.g., a small number) 812; a symbol (with a large number) 811 provided in the center of the candidate's frame, or a text title such as “Poster Display Area” or “xx Governor Election” 814. The smartphone then recognizes these as shapes, numbers, or characters. Furthermore, if a candidate's election poster is displayed, it recognizes the QR code 87 with which the poster ids provided.

Next, the server determines what voters are looking at in which location (election poster claim boards, street speeches, newspaper campaign ads, etc.) by comparing the data with the database 89 and automatically downloads the previously-specified data to smartphones according to the location. For example, this dedicated application at a poster board location can, after downloading and displaying a candidate's poster and other materials, conduct an oral question and answer session with the generative AI 88 of this invention which has been trained with that candidate's information.

The processing procedures for such a dedicated application may differ from time to time, depending on the conditions, or may be predetermined by the voter.

This method allows for highly accurate candidate information from the generative AI of the invention.

Even if candidates do not put up posters, voters can easily obtain significant quantities of candidate information or political organizations as described above.

The application to be downloaded to the smartphone may be a dedicated app for a given candidate or political group, or it may be an application issued by an election commission, for example, that can be linked to all candidates or political groups.

When the poster is posted, the link can be read with a 2-dimensional code reader, which is a well-known feature of smartphones.

The candidate may also conduct oral question and answer sessions using the generative AI 88 of the present invention directly from the candidate's homepage.

### 17th Embodiment of the Invention

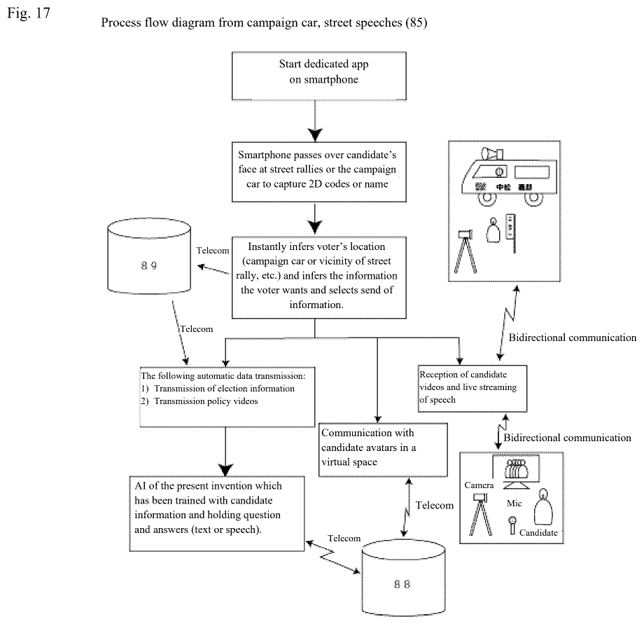

FIG. 17 is a process flowchart showing the 14th embodiment, which is a more specific version of the 12th embodiment of the invention, and is the flow of processing in a dedicated application in a campaign cars or street speeches 85.

Voters hold their smartphone cameras over the candidate's face (candidate's photo, likeness, name, or 2-dimensional code) after launching the dedicated application, and the server determines where and what the voter is looking at by comparing it with the database 89 through facial recognition or character recognition, and transmits the materials. For example, when a candidate is speaking on the street, the system will automatically and instantly download videos of election bulletins and policies. The system then connects to the generative AI 88 of the invention, which has been trained (data stored) with the candidate information, to answer questions by voice.

After linking with the dedicated application, users can also communicate virtually with an avatar of the AI 88 generated by this invention, which has been trained with candidate information similar to that of the candidate.

Remote live webcasts with candidates are also possible.

By using this generative AI 88 of the invention which has been trained with candidate information, it is possible to answer questions with high accuracy and greatly reduce the physical burden on the candidates themselves.

The candidate information also includes knowledge information or political organization information, such as the candidate's biography, orders received, inventions, SNS and other conversations and postings, interview information, family information, political organization claims, and background. The AI 88 is then trained to take each of these pieces of information and incorporate the methods of embodiments 1-7 so that it can respond appropriately.

### 15th Embodiment of the Invention

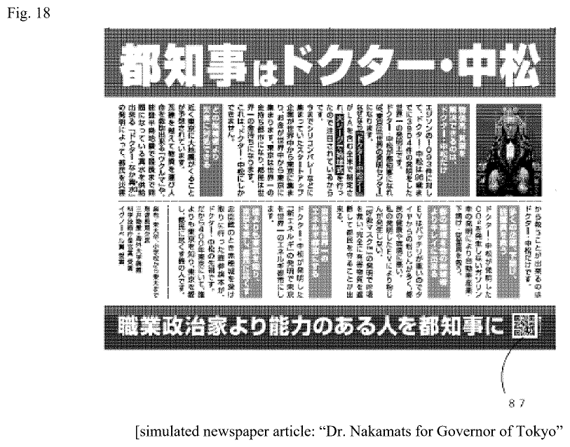

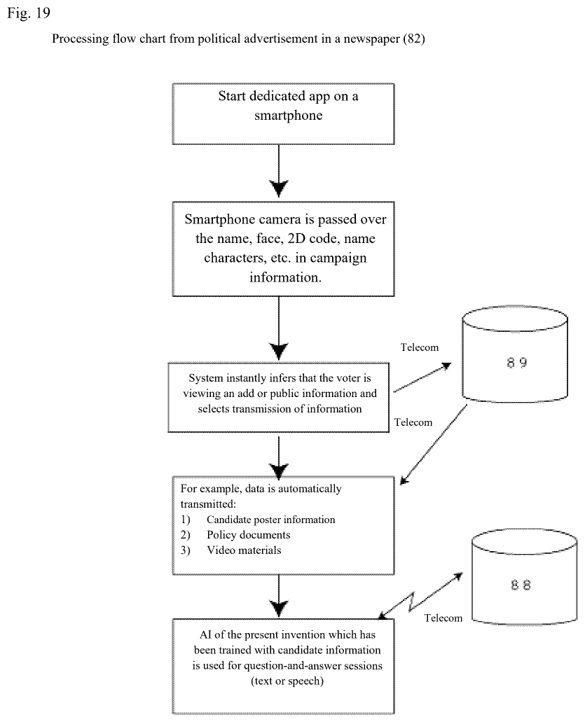

FIGS. 18 and 19 illustrate the 15th embodiment of the invention. FIG. 18 is an example of an election bulletin 83 with a two-dimensional code 87, and FIG. 19 is a processing flowchart from an election ad 82 or election bulletin 83 published in a newspaper.

When the dedicated application installed on the smartphone is activated and held over the face, name, or 2-dimensional code 87 of the candidate list in the Election Gazette, the server recognizes the image or characters, determines that the voter is looking at the Election Gazette or other documents by referring to the candidate information database 89, and starts sending poster materials of that candidate, The server then starts sending the candidate's poster materials, policy materials (election bulletins, newspaper ads), and video materials to the smartphone instantly and automatically, and then connects with the AI 88, which has been trained with the candidate information, to conduct question-and-answer sessions with voters.

This process can also be used to connect with the generative AI 88 of the invention which has been trained with candidate information by having the voter's smartphone recognize the facial image of a given candidate in a televised political broadcast to conduct a question-and-answer session with voters.

### 16th Embodiment of the Present Invention

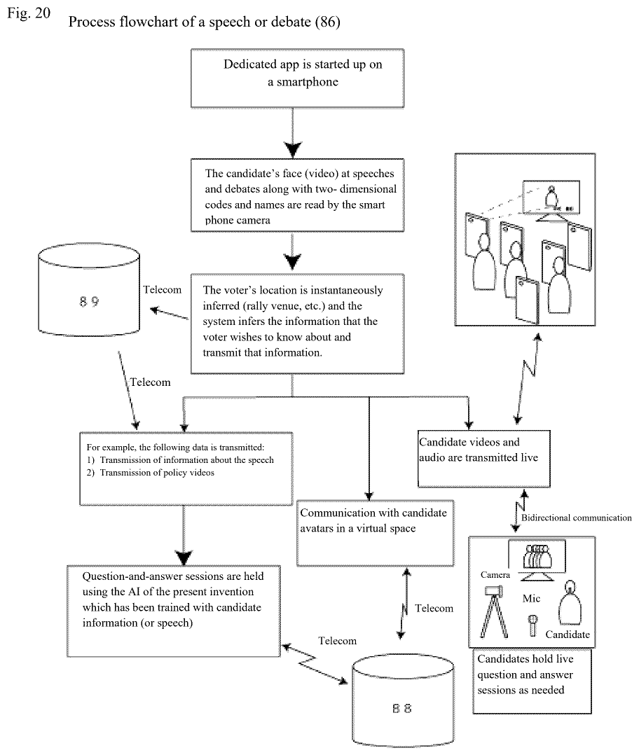

FIG. 20 is a process flowchart of the 16th embodiment of the invention, showing the process for holding online 86 candidate lectures and debates 86.

When voters activate the dedicated application installed on their smartphones, they press a link to information about the lecture or debate to participate at a time communicated to them in advance by the candidate or political organization. Voters can attend and participate in real venues for lectures and debates, or they can participate at home via a dedicated application on their smartphones or computers.

When the voter is at a rally, for example, the voter can hold a smartphone camera over the candidate's face or 2-dimensional code with a dedicated application, and the content of the speech will be immediately transmitted, then connected to the generative AI 88 of the invention which has been trained with the candidate's information, allowing a question and answer session with the voter.

After linking with the dedicated application, users can also communicate virtually with an avatar of the AI 88 generated by this invention, which has been trained with candidate information similar to that of the candidate.

Remote live webcasts with candidates are also possible.

Candidates provide video and audio with microphones and cameras at home, for example, to video and audio display devices in lecture halls and debates, or to voters' smartphones and computers. Live interactive video and audio communication is also possible.

Candidates may choose to have their speeches audio-recorded in advance and distributed to voters at actual rally or debate venues and to the candidate's smartphone, so that they can participate and respond online only during question time. The burden on candidates is reduced because these are responses only.

The use of the aforementioned generative AI of the invention 88 and avatars can greatly reduce the physical burden on the candidates themselves.

### 17th Embodiment of the Invention

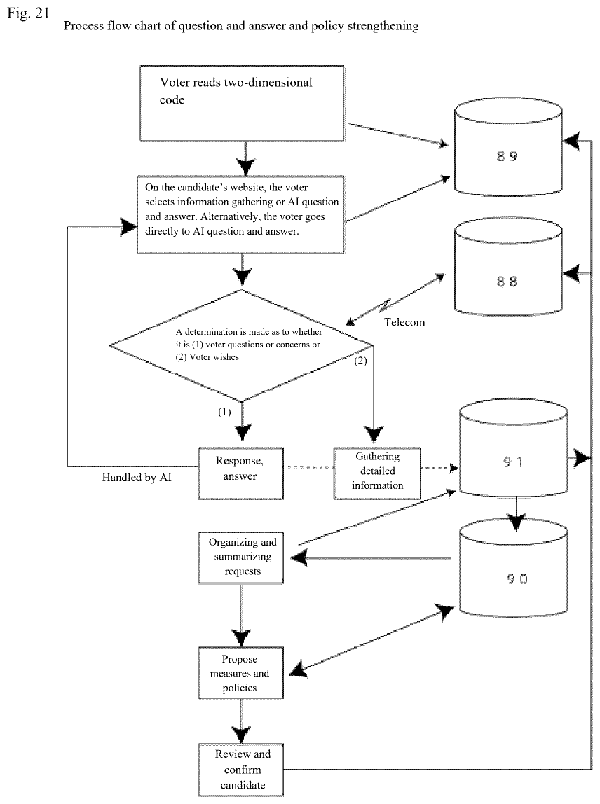

FIG. 21 shows the 17th embodiment of the invention, where a dedicated site is provided on the server instead of on a dedicated application. Here, the voter goes to the dedicated site on the server by using a known read link function such as a 2-dimensional code 87 on a candidate's flyers or posters, or by using a browser search to conduct a question and answer session with a trained generative AI 88 of the invention (e.g., ChatGPT) that incorporates information about the candidate's knowledge, philosophy, policies, policies, basic education or political organization (i.e., candidate data information).

The knowledge of the above trained AI can respond to questions from people all over the world and can represent the claims of candidates, especially with regard to politics.

The inventor has named this system “Answer Mars”.

### 18th Embodiment of the Invention

The 18th embodiment of the invention, shown in FIG. 21, is an even more precise version of the 17th embodiment, wherein information on questions and answers conducted with a generative AI 88 of the invention which has been trained that incorporates candidate data or information on requests and issues expressed by voters which is converted from voice to text and converted into a database 91. This system is a system that uses other-generative AI 90 of the invention which has been trained in politics and policy, which is distinct from the trained AI that incorporates candidate data, to organize and aggregate the information, generate countermeasures, and feed them back into the candidate information database 89 and the trained generative AI 88 of the invention.

Details of the system performs the feedback illustrated in FIG. 18 are described below:

In question-and-answer sessions with a trained generative AI 88 of the invention that incorporates voter and candidate data, the generative AI of the invention determines whether the meaning of the voter's voice is a question or doubt about the candidate, or a request, complaint, issue, or problem with the whole process. In other words, it categorizes whether a question should be answered or not. It will then respond to questions, requests, burning issues, and other problems, and will listen for detailed information to elicit specific details from the voters. All conversations (written or spoken) are converted to text and stored in a database 91. The other AI 90 which has been trained on social information such as political policies organizes all the information into questions or complaints, and further classifies them into policy categories. The other generative AIs of the invention then generates policy measures. Once the candidate has confirmed the content of the policy measures, the candidate revises of the data 89 pertaining to the candidate's policies, and the generative AI 88 of the present invention is trained with the candidate's information and is further updated to the generative AI using the methods of embodiments 1~7 of the present intention.

The information circulated as above has a genuinely positive impact on the country by addressing the differences between the policies of the candidates and the demands of voters and the issues with which they are confronted. This further enhances the candidate's policies and clarifies what the candidate should do as a candidate for office.

### 19th Embodiment of the Invention

The 19th embodiment of the present invention provides 2-dimensional codes on book covers, obis [sashes], magazines, books, newspapers, music scores, user manuals, comic books, and other printed materials, or stationery such as notepads and notebooks, or photographs. The reader can connect with the trained generative AI of the invention, which has accumulated content description data, and ask questions by voice or text, and receive answers from the generative AI of the invention.

According to the 19th embodiment of the invention, reading books and other printed materials can be even more enjoyable.

### 20th Embodiment of the Invention

In the 20th embodiment of the invention, a product or its user manual is provided with a 2-dimensional code, and when the reader holds up a smartphone, he or she can connect with the generative AI of the invention trained with the information, structure, and details of the product description to answer questions via text or voice.

According to the 20th embodiment of the invention, the product can be easily and readily handled and understood.

The invention shown in the 20th embodiment is not limited to products and documents with 2-dimensional codes, but includes all information that should be explained to a third party with a smartphone, such as structure, handling, etc., including the process of connecting to a trained AI that generates the invention and answering questions by smartphone. The invention includes all processes that connect the smartphone to a trained generative AI of the invention for question-and-answer sessions.

The above-described AI of the present invention is an example of the inventor's invention, as shown in JP 2022-136374.

The same information about individuals who have passed away or past facts may be added to the IC chip to train the aforementioned generative AI of the invention. This allows, for example, in the case of elections, information such as old party policies and examples to be input to enable highly accurate party responses.

Any generative AI that is a variation of the present invention is included in the present invention.

### INDUSTRIAL APPLICABILITY

The present invention has great potential for industrial use as it will provide a foundation for further development in the industry.

### EXPLANATION OF SYMBOLS

1 Question
2 AI
2n AI of the n kind
3 Answer
31 Highly-precise response
32 Highly-precise answers with English input
3n Highly-precise answers with repeated questions
4 Answer n−1 and question n generation (n=2, 3, 4 . . . - . . . )
5 Questions and answers
61 Question in Japanese
611 Question in Japanese (voice)
62 Automatic, machine translation
621 Automatic translation function from Japanese to English
622 Automatic translation function from English to Japanese
63 English question
64 Generative AI
65 Answer in English
66 Answer in Japanese
6661 Answer in Japanese (audio)
67 Highly-precise translation
671 Automatic translation function from Japanese to English
672 Automatic translation function from English to Japanese
68 Highly-precise voice translation function
681 Highly-precise voice translation (Japanese to English)
682 Highly-precise voice translation (Japanese to English)
691 Speech-to-text conversion
692 Text-to-speech conversion
6100 Highly-precise answer function
6101 Highly-precise answers (Q)
6102 Highly-precise answers (Answer)
76 The invention of the church's “confessional, toilet room 61, etc., “worries consultation room”
761 Toilet
762 Door
763 Person seeking counseling
77 Inventive device
771 Main unit
772 Speaker
773 Microphone
78 Coin box
79 Grave of this invention
710 Butsudan (Buddhist altar) of this invention
711 Written or spoken questions and answers in Japanese
712 Written questions and answers in English
713 Automatic document translation and automatic speech translation
80 Participation in campaign for election
81 BBS
811 Number for poster (large)
812 Number for poster (small)
813 Bulletin board frame
814 Text titles such as “ . . . Election Poster Display Area
82 Newspaper election ads
83 Official gazette for elections
84 Broadcast of political views
85 Campaign cars and street speeches
86 Lectures and debates
87 2-dimensional code
88 This AI trained with candidate information (accumulated learning)
89 Candidate information database
90 This AI trained with political, policy and current events information
91 Database of voter information categorized in detail, including requests and questions

1. A reflective generative AI system characterized in that the AI memorizes and stores the thoughts of respondents in advance, and then the AI outputs them to respond to inquirers such as voters or product purchasers.

2. The reflective generative AI system of claim 1, wherein posters, election bulletins, products, etc. are provided with QR codes (registered trademark) or other codes that mediate with the aforementioned generative AI.

3. The reflective generative AI system of claim 1, wherein the AI asks further questions to the AI, such as “Is that right?

4. The reflective generative AI system of claim 3 is characterized by repeating the above questioning n times.

5. The reflective generative AI system of claim 1 is characterized in that questions in non-English languages such as Japanese are first converted into English text through a translation system, and then the English questions are asked to the aforementioned generative AI, and the English answers are output in a non-English language, such as Japanese.

6. The reflective generative AI system of claim 1, wherein the AI system answers the advisor's consultation by providing a device with the AI system that has accumulated life consultation information, a microphone, and a loudspeaker, and an object to enclose the microphone and loudspeaker, taking privacy into account.

7. The reflective generative AI system of claim 1, wherein a device with the aforementioned Generative AI System that stores information on the deceased and ancestors, a microphone and a speaker are installed on a grave or in a stone or on a butsudan [Buddhist family altar] to enable interaction with the deceased and ancestors.

8. The reflective generative AI system of claim 1, wherein a QR code (registered trademark) or other connection function is provided on posters, election bulletins, and other election-related materials in an election campaign, and said generative AI system responds to inquirers by text or voice.

9. The reflective generative AI system of claim 1, wherein the AI system generates a text or voice response to an inquirer by holding a smartphone or other communication device of a voter with a dedicated application installed over the numbers or frames on the poster or the text on the election poster, and wherein the AI system responds to the inquirer by text or voice.

10. The reflective generative AI system of claim 1, wherein a connection function such as a QR code (registered trademark) is provided on printed matter such as book covers and obis, magazines, newspapers, sheet music, user manuals, etc., and the aforementioned generative AI System responds to inquirers by text or voice.

11. The reflective generative AI system of claim 1, wherein a connection function such as a QR code (registered trademark) is provided in the product or its user manual, and the aforementioned generative AI system responds to the questioner by text or voice.

12. The reflective generative AI system of claim 5, wherein a first AI system classifies the questions asked by the inquirer into categories and responds to the questions that require a response, and wherein the first AI system accumulates information on countermeasures to improve the accuracy of the first AI system's answers.
